(19) United States
(12) Patent Application Publication
(10) Pub. No.: US 2015/0309400 A1
(43) Pub. Date: Oct. 29, 2015

(54) LIGHT SOURCE MODULE AND IMAGE PROJECTION DEVICE

(71) Applicant: Hitachi-LG Data Storage, Inc., Tokyo (JP)

(72) Inventors: Tomoto KAWAMURA, Tokyo (JP); Satoshi OOUCHI, Tokyo (JP); Yoshiho SEO, Tokyo (JP); Toshiteru NAKAMURA, Tokyo (JP); Yuya OGI, Tokyo (JP)

(73) Assignee: Hitachi-LG Data Storage, Inc., Tokyo (JP)

(21) Appl. No.: 14/695,886

(22) Filed: Apr. 24, 2015

(30) Foreign Application Priority Data
Apr. 25, 2014 (JP) 2014-091026

(51) Int. Cl. G03B 21/20; G03B 21/16; G03B 21/00

(52) U.S. Cl. CPC G03B 21/2013; G03B 21/006; G03B 21/16; G03B 21/2033; G03B 21/2053; G03B 21/2086; G03B 21/208

(57) ABSTRACT

A light source module and an image projection device which can have high resolution and high optical efficiency are provided with a simple optical system. A light source module includes a light source unit formed by a plurality of stacked light emission surfaces which emit lights of at least red, blue, and green wavelength bands, and a light-source drive and control unit which supplies a driving current to the respective light emission surfaces of the light source unit. Each of the light emission surfaces of the light source unit has a nanostructure smaller than a wavelength of visible light near a p-n junction provided in a semiconductor having a larger band gap than the visible light, and emits a light of a corresponding one of the wavelength bands via a phonon level.

### CLAIM OF PRIORITY

The present application claims priority from Japanese patent application serial No. JP 2014-091026, filed on Apr. 25, 2014, the content of which is hereby incorporated by reference into this application.

### BACKGROUND OF THE INVENTION

1. Field of the Invention

The present invention relates to a light source module which generates lights of a plurality of wavelengths and an image projection device using the same.

2. Background Art

General known techniques for colorizing an image to be displayed include a method for providing a color filter which splits light from a monochromatic light source into three colors, as shown in Japanese Unexamined Patent Application Publication No. 4-179920, and a method for preparing light sources of three colors and displaying images of three colors in a time division manner, as shown in Japanese Unexamined Patent Application Publication No. 10-186311, for example.

### SUMMARY OF THE INVENTION

The method for providing the color filter which splits the light from the light source into three colors as described in Japanese Unexamined Patent Application Publication No. 4-179920 enables a simple optical system to be used. However, in this method, the area of one pixel in a display surface increases, and there are therefore problems of physically low resolution and low optical efficiency, for example. On the other hand, the method for providing independent light sources of three colors as described in Japanese Unexamined Patent Application Publication No. 10-186311 enables high-resolution display, but has a problem of a complicated optical system.

It is an object of the present invention to provide a light source module and an image projection device which have high resolution and high optical efficiency with a simple optical system.

A light source module of the present invention includes a light source unit having a plurality of stacked light emission surfaces configured to emit lights of at least red, blue, and green wavelength bands, and a light-source drive and control unit configured to supply a driving current to each of the light emission surfaces of the light source unit. Each of the light emission surfaces of the light source unit has a nanostructure smaller than the wavelength of visible light near a p-n junction provided in a semiconductor having a band gap larger than the visible light, and emits a light of a corresponding wavelength band in a phonon level.

An image projection device of the present invention includes the aforementioned light source module, a display unit configured to irradiate a display element with the light emitted by the light source module to generate an image, and a projection unit configured to project the image generated by the display unit.

According to the present invention, it is possible to contribute to reduction in the size and weight, improvement of the resolution, and power saving in image projection devices for mobile use such as a pico-projector or a head mounted display.

### BRIEF DESCRIPTION OF THE DRAWINGS

These and other features, objects and advantages of the present invention will become more apparent from the following description when taken in conjunction with the accompanying drawings wherein:

FIGS. 1A and 1B are structure diagrams showing an embodiment of a light source module (first embodiment);

FIG. 2 is a diagram simply illustrating the principle of light emission of a light source unit;

FIG. 3 is a structure diagram showing an embodiment of an image projection device (second embodiment);

FIG. 4 is a system block diagram of the image projection device;

FIGS. 5A and 5B show an exemplary driving current by a light-source drive and control unit (third embodiment);

FIGS. 6A, 6B, and 6C each show wavelength bands of light emission of the light source unit (fourth embodiment);

FIGS. 7A and 7B show another exemplary structure of the light source module (fifth embodiment);

FIG. 8 shows another exemplary structure of the image projection device (sixth embodiment);

FIG. 9 shows still another exemplary modification of the image projection device; and

FIG. 10 shows still another exemplary modification of the image projection device.

### DETAILED DESCRIPTION OF THE EMBODIMENTS

Embodiments of the present invention are described below, referring to the drawings.

### First Embodiment

In the first embodiment, a light source module is described.

FIGS. 1A and 1B are structure diagrams showing an embodiment of the light source module, and FIG. 1A is a front view and FIG. 1B is a cross-sectional view. The light source module 1 is formed by a light source unit 11, a light source substrate 12, a light-source drive and control unit 13, and a temperature monitor unit 14. The light source unit 11, the light-source drive and control unit 13, and the temperature monitor unit 14 are mounted on the light source substrate 12. The respective components are described below.

The light source unit 11 has a structure in which a light emission surface 111 which emits a light of a red wavelength band, a light emission surface 112 which emits a light of a green wavelength band, and a light emission surface 113 which emits a light of a blue wavelength band are stacked, and the stacked light emission surfaces 111, 112, and 113 are held by substrates 114, 115, and 116 made of indium tin oxide (ITO) and a substrate 117 of sapphire. Each of the light emission surfaces 111, 112, and 113 is a p-n junction semiconductor (e.g., poly-3-hexylthiophene (P3HT) as a p-type semiconductor and zinc oxide (ZnO) as an n-type semiconductor are joined), on a surface of which a nanostructure smaller than the wavelength of visible light is formed of silver (Ag), for example. The respective light emission surfaces 111, 112, and 113 emit lights of different wavelength bands from one another by differences among the configurations of the nanostructures thereof. Although the light source unit 11 is arranged at the center of the light source substrate 12 in FIG. 1A, the arrangement of the light source unit 11 is not limited thereto.

The light source substrate 12 is a rigid substrate as used for an LED, for example, provides the strength of the light source module 1, and has electric lines arranged on front and rear surfaces thereof. The light source substrate 12 is also provided with an electric contact with the outside so that the light source substrate 12 can be electrically controlled from the outside. By arranging the electrical contact on the back surface of the light source substrate 12, it is possible to reduce the size of the light source module 1.

The light-source drive and control unit 13 is an electronic circuit having a function of controlling a current to be supplied to the light source unit 11. More specifically, the light-source drive and control unit 13 has a function of applying a pulse current in a plurality of patterns to cause the light source unit 11 to emit light of a plurality of wavelength bands. The light-source drive and control unit 13 may be arranged outside the light source module 1 and control the light source unit 11.

The temperature monitor unit 14 has a function of measuring the temperature of the light source module 1. A thermocouple may be used, for example. The light source unit 11 has light emission characteristics such as the wavelength band and the amount of emitted light, which can be changed by the surrounding temperature. Therefore, the light-source drive and control unit 13 has a function of adjusting a current value and a pulse duration of a driving pulse in accordance with the temperature measured by the temperature monitor unit 14 for stabilizing the light emission characteristics.

The light source module 1 has a light source module cover on the light emission side thereof, although it is not shown in FIGS. 1A and 1B. The light source module cover can prevent the light source unit 11 from being soiled or the light-source drive and control unit 13 from being damaged when a user operates the light source module 1, and is formed of heat-resistant semitransparent resin. In addition, the light source module cover may be provided with a reflector for converting light traveling to a periphery thereof into light traveling forward of the light source unit 11, because the light source unit 11 is a spontaneous emission light source.

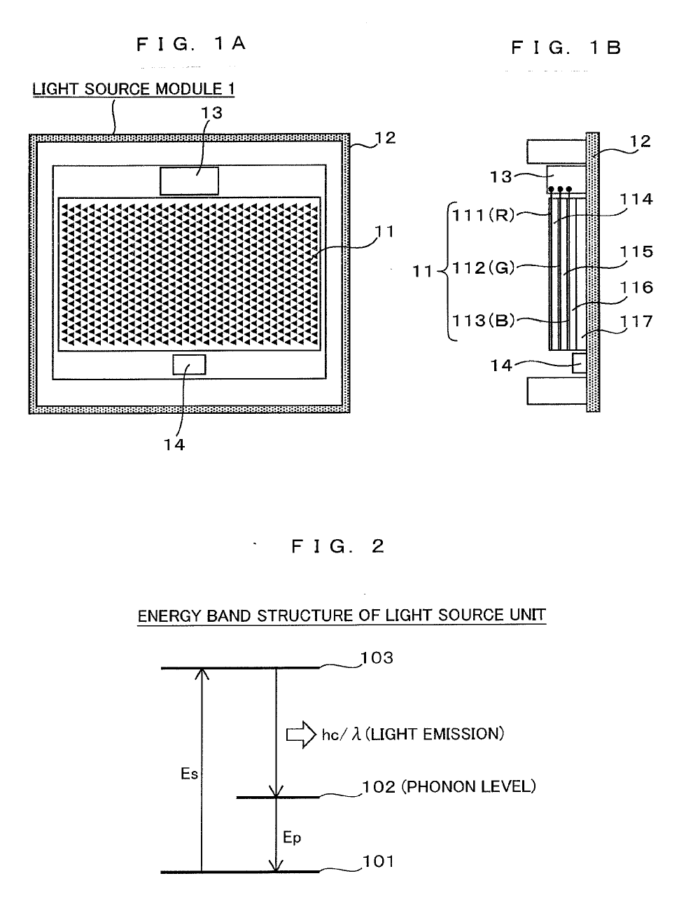

FIG. 2 illustrates the principle of light emission by the light source unit 11 and shows an energy band structure of the light source unit. When a current is applied to the light emission surface 111, 112, or 113, lattice vibration (hereinafter, referred to as phonon) is induced in a surface layer of the nanostructure because electrons move around in the semiconductor. Due to the energy of this phonon, emission of visible light is enabled with energy smaller than a band gap of the p-n junction semiconductor. By the applied current, the energy moves from a valence band 101 to a conduction band 103 and the phonon is induced at the same time. The band gap of this phonon is a phonon level 102. Therefore, the energy in the conduction band 103 moves back to the valence band 101 as heat, and a path in which the energy in the conduction band 103 moves back to the valence band 101 via the phonon level 102 is also generated. When an energy corresponding to the difference between the conduction band 103 and the phonon level 102 is equal to energy of visible light (hc/λ), a light having a specific wavelength λ can be emitted in place of the heat.

The nanostructure for causing emission of the light of the specific wavelength is formed by irradiating the p-n junction semiconductor with the light of the specific wavelength while a bias voltage is applied to the p-n junction semiconductor which is being heated. The irradiation with the light of the specific wavelength causes autonomous formation of a silver nanostructure which induces a predetermined phonon with the light of that wavelength.

As described above, by providing the nanostructure smaller than the wavelength of the visible light near a p-n junction provided in the semiconductor having a larger band gap than the visible light, it is possible to emit visible lights of desired red, blue, and green via the phonon level. Although the nanostructure is described as an example in this embodiment, the same phonon level can also be obtained by setting the density of impurities implanted into the surface layer to have a density distribution shorter than the wavelength of the visible light. This operation is also called as “dressed-photon principle”.

According to this embodiment, the light source unit 11 has a structure in which a plurality of light emission surfaces emitting lights of different wavelength bands from each other are stacked. Thus, lights of a plurality of wavelength bands can be emitted by a single light source module in a switching manner and it is therefore unnecessary to include a plurality of independent light sources. Accordingly, a light source module having a simple structure can be provided to a system which requires a light source of a plurality of colors.

### Second Embodiment

In the second embodiment, an image projection device using the light source module is described.

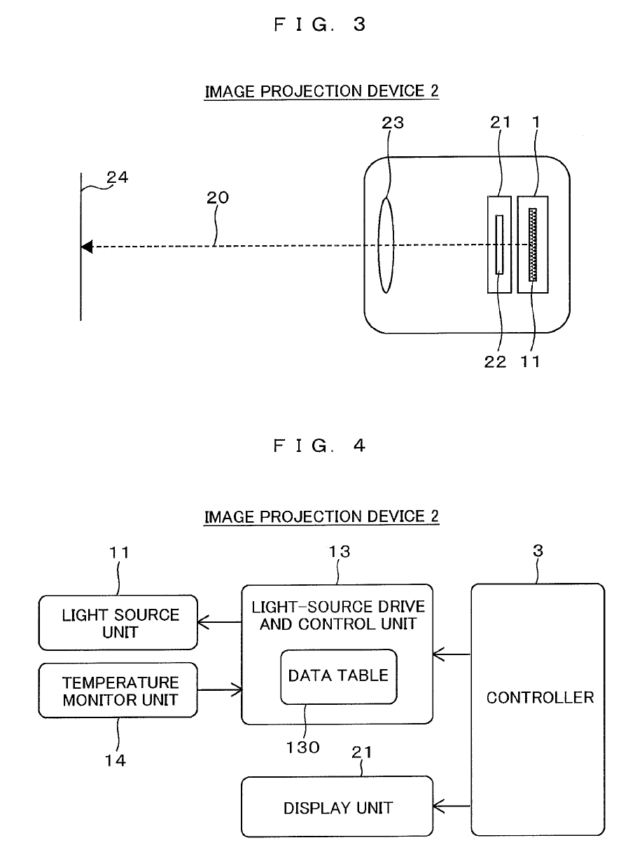

FIG. 3 is a structure diagram showing an exemplary image projection device. The image projection device 2 includes the light source module 1, a display unit 21, and a projection unit 23.

The light emitted from the light source module 1 is incident on the display unit 21, and an image is generated by a display element 22 in the display unit 21. The image generated by the display element 22 is projected by the projection unit 23 to the outside of the image projection device 2, thereby a projected image 24 is displayed. Please note that broken line 20 shows the traveling direction of a main part of the light for description.

The display element 22 which generates the image is a transmissive liquid crystal display element in which a liquid crystal element is arranged in every pixel, for example. The liquid crystal elements are sandwiched between polarization filters arranged on the light-incident side and the light-emission side thereof. The projection unit 23 is formed by a projection lens and forms the image of the display element 22 as the projected image 24. The projected image 24 is not limited to a real image, but may be a virtual image.

The light source unit 11 of the light source module 1 is designed to be larger than the area of the display element 22 of the display unit 21, because the light source unit 11 has to illuminate the display element 22 so that the whole of the display element 22 becomes bright. The shape of the display unit 21 is usually a rectangle having an aspect ratio of 4:3 or 16:9. Thus, it is possible to effectively use the light emitted from the light source unit 11 by designing the shape of the light source unit 11 to be a rectangle that is the same as the display unit 21.

For displaying a color image, a field sequential color method is employed. That is, one color image is split into red, green, and blue monochromatic images, and those monochromatic images are displayed while being shifted by time. The display element 22 generates each split image. The light source unit 11 emits red, green, and blue lights in synchronization with the respective images generated by the display element 22. Thus, the light-source drive and control unit 13 controls the light source unit 11 in synchronization with the display unit 21.

FIG. 4 is a system block diagram of the image projection device 2. When an instruction to display an image is input to a controller 3 arranged in the outside, the controller 3 transmits an image signal to the display unit 21. The display element 22 of the display unit 21 generates images of red, green, and blue in a time multiplexing manner. Simultaneously the controller 3 also transmits a timing signal for generating an image to the light-source drive and control unit 13. The light-source drive and control unit 13 supplies a driving current to the light source unit 11 at a predetermined timing by the timing signal so that the light source unit 11 emits red, green, and blue lights in synchronization with the display unit 21. The light-source drive and control unit 13 monitors the temperature obtained from the temperature monitor unit 14, and make adjustment by increasing the driving current and/or the pulse duration while referring to a data table 130 in the light-source drive and control unit 13, in such a manner that a predetermined wavelength band and/or brightness can be obtained.

According to this embodiment, lights of a plurality of wavelength bands can be emitted by a single light source module, and therefore a plurality of independent light sources are not required. Thus, an image projection device with a simple structure can be achieved. In addition, because the field sequential color method is employed, no color filter is required in the display unit 21 and it is possible to project a high resolution image.

In this embodiment, a transmissive liquid crystal display element is used as the display element 22. However, other display elements such as a digital mirror device or LCOS may be applied.

### Third Embodiment

In the third embodiment, an operation of the light-source drive and control unit 13, especially temperature control, is described.

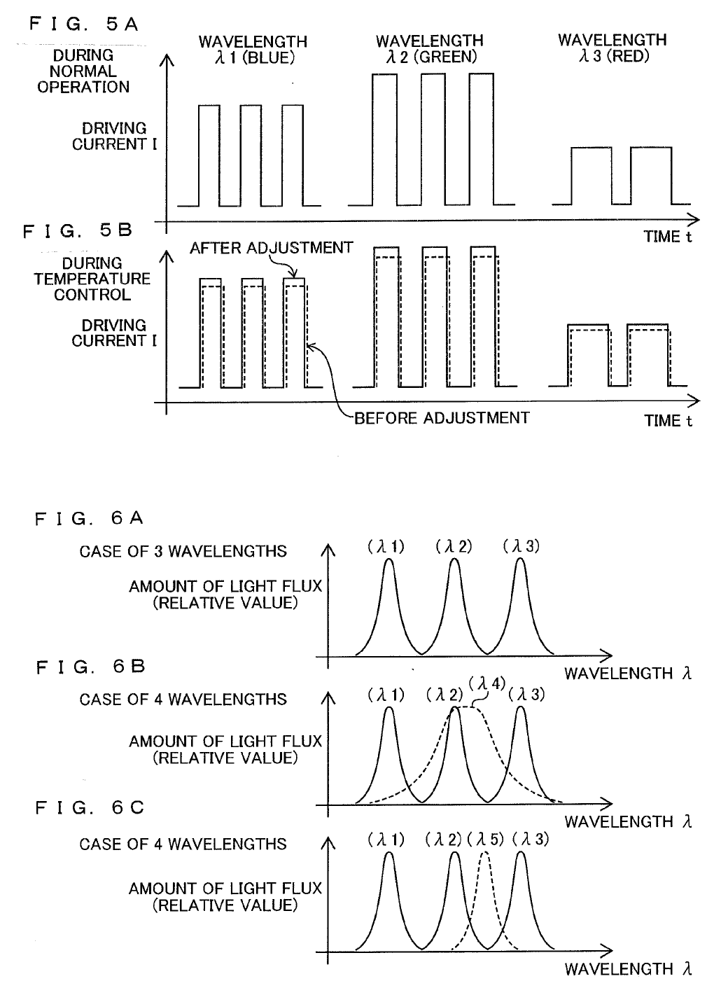

FIGS. 5A and 5B show an exemplary driving current supplied by the light-source drive and control unit 13 during a normal operation and during temperature control, respectively. The vertical axis represents the driving current I to be supplied to the light source unit 11 while the horizontal axis represents the time t, and a current waveform (control signal) is schematically shown for each emitted light (wavelength band).

First, an operation during the normal operation shown in FIG. 5A is described. As described before, the light-source drive and control unit 13 employs the field sequential color method. Thus, the light-source drive and control unit 13 causes emission of a light of a wavelength λ1 (e.g., blue), a light of a wavelength λ2 (e.g., green), and a light of a wavelength λ3 (e.g., red) along the time axis. When causing emission of the light of the wavelength band λ1, the light-source drive and control unit 13 sends a control signal that is a driving pulse for λ1 to the light emission surface 113 of the light source unit 11. Then, when causing emission of the light of the wavelength band λ2, the light-source drive and control unit 13 sends a control signal that is a driving pulse for λ2 and is different from that for λ1 to the light emission surface 112 of the light source unit 11. Then, when causing emission of the light of the wavelength band λ3, the light-source drive and control unit 13 sends a control signal that is a driving pulse for λ3 and is different from those for λ1 and λ2 to the light emission surface 111 of the light source unit 11. As shown in FIG. 5A, depending on the wavelength λ, the pulse height and the pulse duration of the driving pulse (control signal) is set to be different. In this manner, emission of lights of a plurality of wavelength bands can be realized.

Since the driving pulse (control signal) is a high frequency signal, it can be easily affected by a noise when being transmitted from the outside. Thus, the light-source drive and control unit 13 is arranged inside the light source module 1, thereby preventing degradation of the control signal and realizing stable light emission.

Next, an operation during the temperature control shown in FIG. 5B is described. In FIG. 5B, a broken line corresponds to a control signal before adjustment while a solid line corresponds to a control signal after adjustment. The light source unit 11 generates heat because of a current loss or a light loss, for example. When the surrounding temperature is changed by the heat generation, the amount and/or the wavelength band of the light output from the light source unit 11 can also change. Thus, the temperature monitor unit 14 is arranged in the light source module 1 and measures the temperature in the surrounding of the light source module 1.

Moreover, the data table 130 showing a change in the amount of the emitted light in association with a temperature change is stored in advance in the light-source drive and control unit 13. The light-source drive and control unit 13 refers to the data table 130 in accordance with the temperature measured by the temperature monitor unit 14 and increases the driving current and/or the pulse duration as shown in FIG. 5B, thereby making adjustment so that desired wavelength band and/or brightness can be obtained.

According to this embodiment, it is possible to make a color and brightness of an image to be projected stable even if a temperature change occurs.

### Fourth Embodiment

In the fourth embodiment, the wavelength bands in which the light source unit 11 emits lights are described.

FIGS. 6A, 6B, and 6C illustrate the wavelength bands of light emission of the light source unit 11, in each of which the horizontal axis represents the wavelength and the vertical axis represents the amount of light flux (relative value). Three examples shown in FIGS. 6A, 6B, and 6C are described.

FIG. 6A shows a case where the light source unit 11 has three wavelengths. The light source unit 11 has light emission surfaces of three wavelength bands including λ1 (blue), λ2 (green), and λ3 (red), each of which has a predetermined full width at half maximum. For realizing a color reproduction range of 130% or more of NTSC range, it is preferable that the center wavelengths are set so that λ1=450 nm, λ2=515 nm, and λ3=640 nm and the full width at half maximum is set to about 20 nm. Since the light source unit 11 of this embodiment emits light via the phonon level, the light source unit 11 has an advantage of allowing a predetermined wavelength band to be selected independently of the substrate, unlike an LED, and being able to realize an image projection device with a wide color reproduction range easily. In order to set a wavelength band of light emission to a specific full width at half maximum, the wavelength of the light radiated in the above-described process of manufacturing the nanostructure of the light emission surface is selected to be the specific full width at half maximum.

FIGS. 6B and 6C show cases where the light unit 11 has four wavelengths. In a case where the color reproduction range is set to be wide by using three wavelengths, all the center wavelengths of three wavelengths are shifted from 550 nm that has maximum contribution to the brightness. Therefore, for obtaining both the color reproduction range and the brightness, the wavelength of white (λ4 in FIG. 6B) having a broad full width at half maximum or the wavelength of yellow (λ5 in FIG. 6C), which can largely contribute to the brightness, is added. In those cases, one light emission surface is increased in the light source unit 11 and control for splitting one image into four monochromatic images is performed.

### Fifth Embodiment

In the fifth embodiment, a case in which a diffusion unit is provided is described as a modified example of the light source module 1.

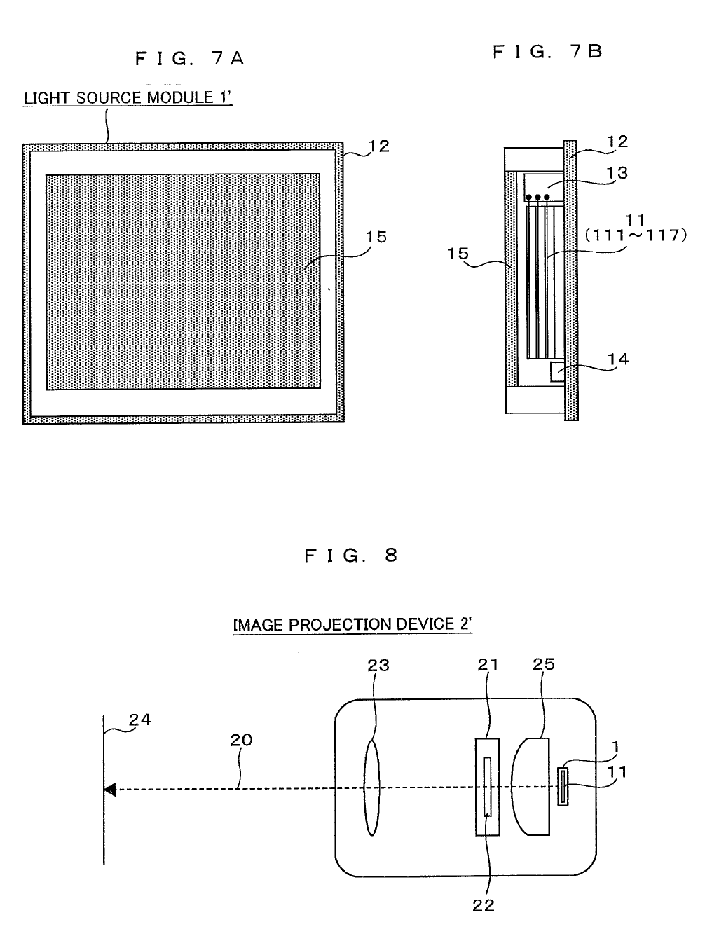

FIGS. 7A and 7B show a structure of another exemplary light source module, and are a front view and a cross-sectional view thereof, respectively. The same components as those in the first embodiment (FIGS. 1A and 1B) are labeled with the same reference numerals and the description thereof is omitted. The light source module 1′ includes the light source unit 11, the light source substrate 12, the light-source drive and control unit 13, the temperature monitor unit 14, and a diffusion unit 15. In comparison with the structure in the first embodiment (FIGS. 1A and 1B), the diffusion unit 15 is provided on the light-emission side of the light source unit 11. The diffusion unit 15 has a function of diffusing a light and can be obtained by making a surface of a transparent plastic plate rough or mixing particles of different refractive indices therein, for example.

A problem in manufacturing the light source unit 11 is to achieve the uniformity of the emitted light on the light emission surface. Without the uniformity of the emitted light, the color and/or brightness of the projected image may be uneven. Thus, by providing the diffusion unit 15 in the light source module 1′, it is possible to improve the uniformity of the emitted light. In other words, an advantageous effect of improvement of variations in manufacturing the light source unit 11 can be obtained by providing the diffusion unit 15.

### Sixth Embodiment

In the sixth embodiment, a structure in which a light collection unit is provided is described as an exemplary modification of the image projection device 2.

FIG. 8 shows the structure of another exemplary image projection device. The same components as those in the second embodiment (FIG. 3) are labeled with the same reference numerals and the description thereof is omitted. The image projection device 2′ includes the light source module 1 (light source unit 11), the display unit 21 (display element 22), the projection unit 23, and a light collection unit 25. In comparison with the second embodiment (FIG. 3), the light source module 1 having a smaller size is used and the light collection unit 25 is provided. Because the light source module 1 is small, the light source unit 11 is sufficiently smaller than the display unit 21 (display element 22).

The light collection unit 25 is a condenser lens and has a function of converting a bundle of light beams emitted from the light source unit 11 at random angles into a bundle of parallel light beams and collecting it. Also, the light collection unit 25 has a function of enlarging the area of the light emitted from the light source unit 11 to about the area of the display element 22. The light emitted from the light source module 1 is incident on the display unit 21 through the light collection unit 25, and an image is generated by the display element 22. The projection unit 23 projects the image generated by the display element 22 to display the projected image 24.

When a bundle of light beams emitted from the light source unit 11 at random angles is used as it is as in the second embodiment (FIG. 3), the light contributing to the projected image is not much and the optical efficiency is low. However, when the light source unit 11 is made smaller and the bundle of light beams is converted into the bundle of parallel beams by the light collection unit 25 as in this embodiment, it is possible to eliminate the useless light and perform efficient light transmission to the display element 22. Thus, the optical efficiency in the image projection device 2′ can be improved significantly.

The structure in FIG. 8 can be further modified in the following manner.

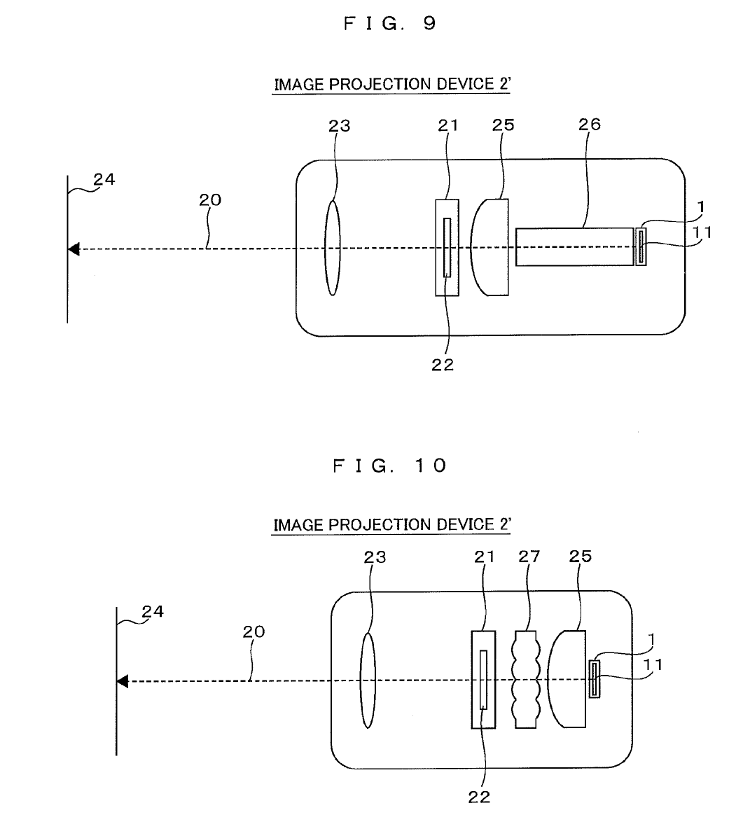

FIG. 9 shows another exemplary modification of the image projection device. The image projection device 2′ further includes a light tunnel 26 arranged between the light source module 1 and the light collection unit 25 in the structure of FIG. 8. The light tunnel 26 has a function of improving the uniformity of the light incident thereon. Therefore, the light emitted from the light source unit 11 passes through the light tunnel 26 before reaching the light collection unit 25, thereby the uniformity thereof can be improved. Consequently, the image projection device 2′ can eliminate unevenness in the color and/or the brightness of the projected image while acquiring the high optical efficiency.

FIG. 10 shows still another exemplary modification of the image projection device. The image projection device 2′ further includes a fly-eye lens 27 arranged between the light collection unit 25 and the display unit 21 in the structure of FIG. 8. The fly-eye lens 27 has a function of improving the uniformity of the light incident thereon. Therefore, it is possible to improve the uniformity of the light by making the light bundle exiting from the light collection unit 25 pass through the fly-eye lens 27. Consequently, the image projection device 2′ can also eliminate unevenness in the color and/or the brightness of the projected image while acquiring the high optical efficiency.

As described above, according to the light source module of the present invention, it is possible to emit lights of a plurality of wavelength bands by a single light source module. Therefore, a small light source can be achieved with a simple optical system. Moreover, the use of this light source module can contribute to reduction in the size and weight, improvement of the resolution, and reduction of the power in image projection devices for mobile use such as a pico-projector and a head mounted display.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A light source module comprising:
a light source unit having a plurality of stacked light emission surfaces configured to emit lights of at least red, blue, and green wavelength bands; and
a light-source drive and control unit configured to supply a driving current to each of the light emission surfaces of the light source unit,
wherein the each of the light emission surfaces of the light source unit has a nanostructure smaller than a wavelength of visible light near a p-n junction provided in a semiconductor having a larger band gap than the visible light, and emits a light of a corresponding one of the wavelength bands via a phonon level.

2. The light source module according to claim 1, further comprising a temperature monitor unit configured to measure a temperature in a surrounding of the light source unit.

3. The light source module according to claim 1, wherein the light emission surfaces of the light source unit include a light emission surface configured to emit a light of a white wavelength band having a broad full width at half maximum, or a light of a yellow wavelength band.

4. The light source module according to claim 1, further comprising a diffusion unit configured to diffuse the light emitted from the light source unit.

5. An image projection device comprising:
the light source module according to claim 1;
a display unit configured to irradiate a display element with the light emitted by the light source module to generate an image; and
a projection unit configured to project the image generated by the display unit.

6. The image projection device according to claim 5, wherein the light source unit of the light source module is a rectangle having an area larger than an area of the display element of the display unit.

7. The image projection device according to claim 5, wherein the light-source drive and control unit controls a magnitude and a pulse duration of the driving current to be supplied to the light source unit in synchronization with a timing of a wavelength band of the image generated by the display unit.

8. The image projection device according to claim 7, further comprising a temperature monitor unit configured to measure a temperature in a surrounding of the light source unit,
wherein the light-source drive and control unit adjusts the magnitude and the pulse duration of the driving current to be supplied to the light source unit in accordance with the temperature measured by the temperature monitor unit.

9. The image projection device according to claim 5,
wherein the light source unit of the light source module is smaller than an area of the display element of the display unit, and
a light collection unit configured to collect the light from the light source module is arranged between the light source module and the display unit.

10. The image projection device according to claim 9, further comprising a light tunnel or a fly-eye lens between the light source module and the display unit.
